(19) United States
(12) Patent Application Publication
(10) Pub. No.: US 2026/0182537 A1
(43) Pub. Date: Jul. 2, 2026

(54) Pet Food Storage Device

(71) Applicant: Kelly Andrade, Vacaville, CA (US)

(72) Inventor: Kelly Andrade, Vacaville, CA (US)

(21) Appl. No.: 19/008,044

(22) Filed: Jan. 2, 2025

(51) Int. Cl. A01K 5/01; B65D 71/70

(52) U.S. Cl. CPC A01K 5/0114; B65D 71/70

(57) ABSTRACT

A pet food storage device for storing and serving pre-measured servings of pet food includes a tray having a platform and a pair of legs. The platform is coupled to and extends between the pair of legs. The pair of legs supports the platform over a surface. A plurality of slots extend through the platform. A plurality of cups are positionable within the plurality of slots. Each cup of the plurality of cups is removably positionable within an associated slot of the plurality of slots. Each cup of the plurality of cups includes a base wall and a peripheral wall that is coupled to and extends upwardly from the base wall. A rim is coupled to and extends outwardly from the peripheral wall. The rim is positionable on the platform around the associated slot when the cup is fully inserted into the associated slot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food containers and more particularly pertains to a new food container for storing and serving pre-measured servings of pet food.

### (2) Description of Related Art Including Information Disclosed Under 37 CFR 1.97 and 1.98

The prior art relates to food containers. More specifically, the prior art relates to pet food containers. Many pet owners, particularly dog owners, feed their pets a dry kibble, which can be scooped into a bowl or dish before each meal. Some dog owners feed their dogs pre-packaged and pre-portioned wet foods. Such foods are credited with improved flavor and nutritional value over the kibble alternatives. Because those wet foods are pre-portioned and ready-to-serve, the same bowl or dish can be used as the pet owner would use to serve the dog the kibble. However, those pre-packaged and pre-portioned wet foods can be very expensive. Some dog owners want their pets to receive the nutritional value of a pre-portioned, ready-to-serve wet food, but do not want to pay the high prices for that expensive food. Such owners may make their dogs homemade meals. However, those meals can be time consuming to make, particularly for larger dogs who consume multiple cups of food each day. Thus, there is a need for a device which can be used to store pre-portioned servings of homemade dog food. Such a device would ideally be easy to store in the refrigerator or freezer and would allow the user to remove one portion at a time to feed their dog.

### BRIEF SUMMARY OF THE INVENTION

An embodiment of the disclosure meets the needs presented above by generally comprising a tray having a platform and a pair of legs. The platform is coupled to and extends between the pair of legs wherein the pair of legs is configured to support the platform over a surface. A plurality of slots extend through the platform. The embodiment also includes a plurality of cups. Each cup of the plurality of cups is removably positionable within an associated slot of the plurality of slots. Each cup of the plurality of cups includes a base wall and a peripheral wall that is coupled to and extends upwardly from the base wall. A rim is coupled to and extends outwardly from the peripheral wall. The rim is positionable on the platform around the associated slot when the cup is fully inserted into the associated slot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a pet food storage device according to an embodiment of the disclosure.

FIG. 2 is a front view of an embodiment of the disclosure.

FIG. 3 is a cross-sectional view of an embodiment of the disclosure.

FIG. 4 is a top view of an embodiment of the disclosure.

FIG. 5 is a side view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

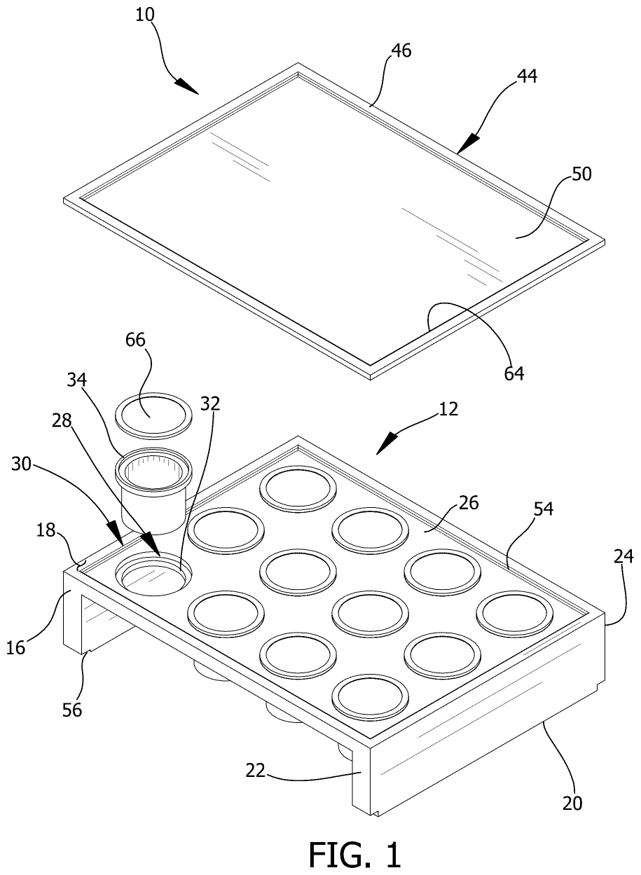

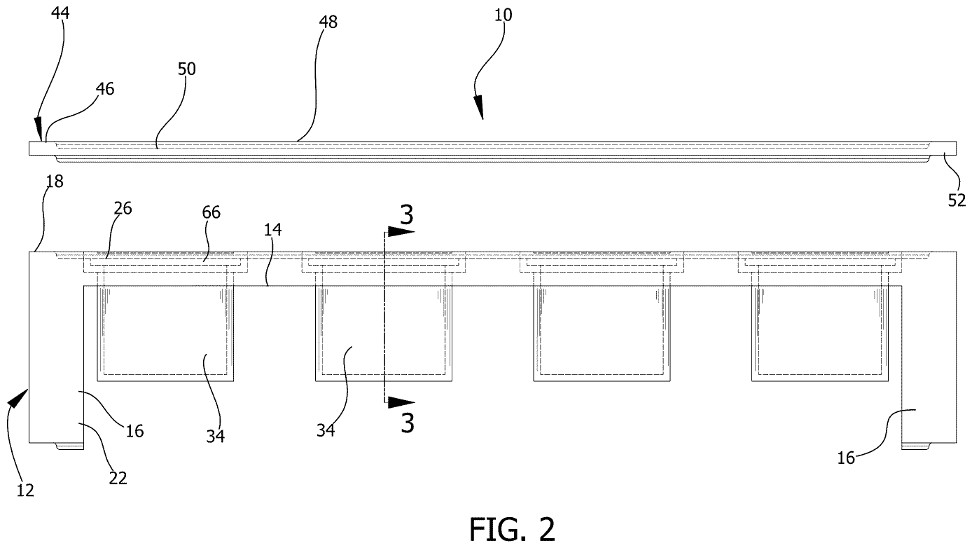

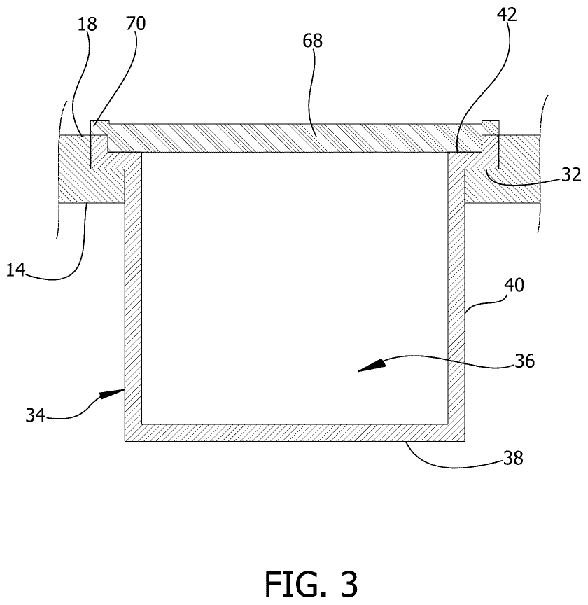

With reference now to the drawings, and in particular to FIGS. 1 through 7 thereof, a new food container embodying the principles and concepts of an embodiment of the disclosure and generally designated by the reference numeral 10 will be described.

As best illustrated in FIGS. 1 through 7, the pet food storage device 10 generally comprises a tray 12 having a platform 14 and a pair of legs 16. The platform 14 is generally coupled to and extends between the pair of legs 16 wherein the pair of legs 16 is configured to support the platform 14 over a surface. The platform 14 may have a top surface 18.

The pair of legs 16 may be positioned on opposing lateral edges of the platform 14. Each leg of the pair of legs 16 may have a length that is coextensive with the opposing lateral edges of the platform 14. Each leg of the pair of legs 16 may have a bottom end 20 that is distally positioned relative to the platform 14. Each leg of the pair of legs 16 may have a front end 22 and a back end 24. Each of the front end 22 and the back end 24 may be perpendicular to the opposing lateral edges of the platform 14.

A tray depression 26 may extend into the top surface 18 of the platform 14. A plurality of slots 28 generally extend through the platform 14. For example, the plurality of slots 28 may be positioned within the tray depression 26. Each slot of the plurality of slots 28 is spaced from an adjacent slot of the plurality of slots 28.

A plurality of channels 30 may extend into the platform 14. Each channel of the plurality of channels 30 is generally positioned around a respective slot of the plurality of slots 28 to define a slot lip 32 extending into the respective slot.

The pet food storage device 10 further includes a plurality of cups 34. Each cup of the plurality of cups 34 is removably positionable within an associated slot of the plurality of slots 28. Each cup of the plurality of cups 34 may have a volume 36 between 3.0 fluid ounces and 9.0 fluid ounces. In other words, each cup 34 may have a volume 36 between approximately 0.5 cup and 1.0 cup.

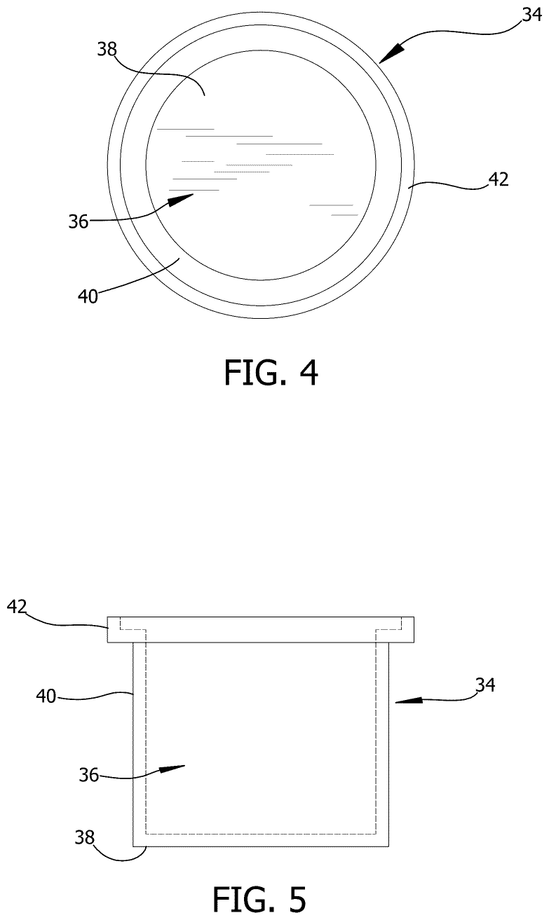

Each cup of the plurality of cups 34 generally includes a base wall 38. The base wall 38 may be circular, as shown in FIG. 4, or the base wall 38 may be another shape. The base wall 38 may be planar. A peripheral wall 40 is coupled to and extends upwardly from the base wall 38 to define the volume 36.

A rim 42 may be coupled to and extend outwardly from the peripheral wall 40. The rim 42 may be positionable on the platform 14 when the cup 34 is fully inserted into the associated slot 28. In embodiments including the plurality of channels 30, the rim 42 may be positionable on the slot lip 32 within the associated slot 28. The rim 42 may have a height that is equal to a distance between the slot lip 32 of the associated slot 28 and the tray depression 26 wherein the rim 42 is coplanar with the tray depression 26 when the cup 34 is fully inserted into the associated slot 28. In embodiments which do not include the tray depression 26, the rim 42 may have a height that is equal to a distance between the slot lip 32 of the associated slot 28 and the top surface 18 of the platform 12 wherein the rim 42 is coplanar with the top surface 18 when the cup 34 is fully inserted into the associated slot 28.

A lid 44 may be removably couplable to the tray 12. The lid 44 generally covers the plurality of slots 28 when the lid 44 is coupled to the tray 12. For example, the lid 44 may include a panel 46 having a panel top side 48. A lid depression 50 may extend into the panel top side 48. A lid lip 52 may be coupled to and extend downwardly from the panel 46. The lid lip 52 releasably engages a perimeter edge 54 of the tray depression 26 to releasably couple the lid 44 to the tray 12. The lid lip 52 may be aligned with the lid depression 50 across the panel 46.

A pair of notches 56 may extend into the bottom end 20 of each leg of the pair of legs 16 of the tray 12. Each notch of the pair of notches 56 is generally positioned on a respective one of the front end 22 and the back end 24 of the pair of legs 16. The pair of notches 56 may have a shape that is configured to complement a shape of an outer edge 64 of the lid depression 50 wherein the pair of legs 16 are configured to releasably engage the lid 44 to facilitate a user in stacking the tray 12 on a second tray 58 when the lid 44 is coupled to the second tray 58.

The pet food storage device 10 may also include a plurality of caps 66. Each cap of the plurality of caps 66 is removably couplable to an associated cup of the plurality of cups 34. More specifically, each cap of the plurality of caps 66 is generally configured to close the associated cup of the plurality of cups 34. For example, each cap of the plurality of caps 66 may close the associated cup of the plurality of cups 34 to maintain freshness of the food 62 stored within the volume 36 of the associated cup of the plurality of cups 34.

Each cap of the plurality of caps 66 may include a plate 68. The plate 68 generally has a diameter that is complementary to a diameter of the rim 42 wherein the plate 68 is positionable to rest on the rim 42 while each cap of the plurality of caps 66 is coupled to the associated cup of the plurality of cups 34. A ridge 70 may be coupled to and extend upwardly from the plate 68. For example, the ridge 70 may be configured to facilitate removal of each cap of the plurality of caps 66 from the associated cup of the plurality of cups 34. The ridge 70 may be positioned to cover a perimeter edge of the plate 68. The ridge 70 generally has a height that is less than a distance between the tray depression 26 and the lid depression 50 wherein each cap of the plurality of caps 66 is couplable to the associated cup of the plurality of cups 34 while the associated cup of the plurality of cups 34 is positioned within the associated slot of the plurality of slots 28.

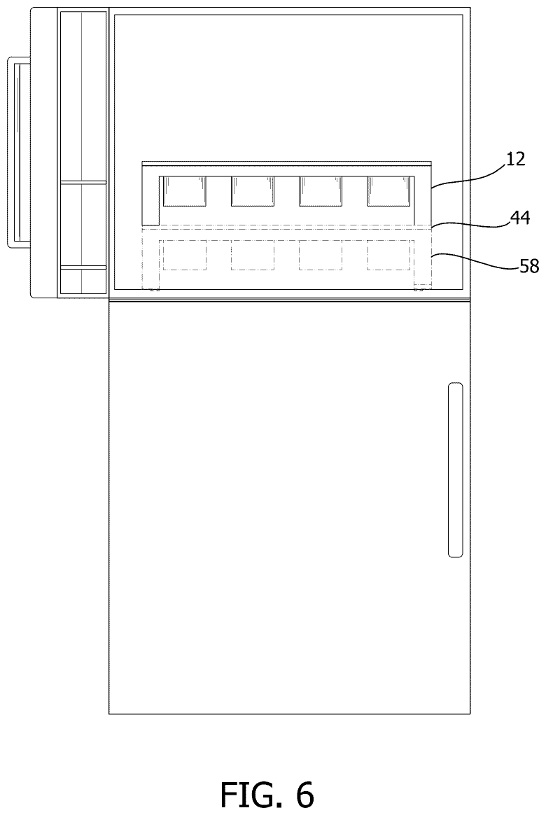

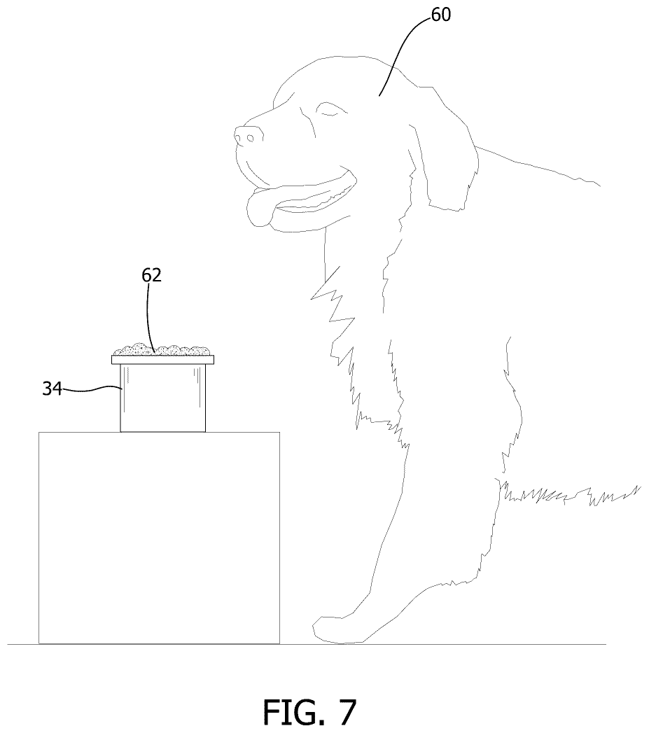

In use, the user can fill the volume 36 of each cup of the plurality of cups 34 with food 62 for a pet 60. For example, the user may prepare twelve meals for the pet 60 using the tray 12 shown in FIG. 1, by filling every cup of the plurality of cups 34 with the food 62. The user may store the food 62, and the pet food storage device 10, in the freezer until the user is ready to serve the food 62 to the pet 60. To prepare more meals, the user may use the second tray 58, as shown in FIG. 6. The second tray 58 may be stacked on top of the tray 12 using the notches in the pair of legs 16 and the lid depression 50 on the lid 44. The user may remove each cup of the plurality of cups 34 individually from the tray 12 to feed the pet 60, as shown in FIG. 7.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A food storage assembly comprising:
a tray having a platform and a pair of legs, the platform being coupled to and extending between the pair of legs wherein the pair of legs is configured to support the platform over a surface;
a plurality of slots extending through the platform;
a plurality of cups, each cup of the plurality of cups being removably positionable within an associated slot of the plurality of slots, each cup of the plurality of cups including:
a base wall;
a peripheral wall being coupled to and extending upwardly from the base wall; and
a rim being coupled to and extending outwardly from the peripheral wall, the rim being positionable on the platform around the associated slot when the cup is fully inserted into the associated slot;
a lid being removably couplable to the tray, the lid covering the plurality of slots when the lid is coupled to the tray; and
a plurality of caps, each cap of the plurality of caps being removably couplable to an associated cup of the plurality of cups while the lid is coupled to the tray wherein each cap of the plurality of caps is configured to close the associated cup of the plurality of cups and wherein the lid inhibits removal of the plurality of cups from the plurality of slots.

2. The food storage assembly of claim 1, further comprising a tray depression extending into a top surface of the platform, the plurality of slots being positioned within the tray depression.

3. The food storage assembly of claim 1, further comprising a plurality of channels extending into the platform, each channel of the plurality of channels being positioned around a respective slot of the plurality of slots to define a slot lip extending into the respective slot.

4. The food storage assembly of claim 3, wherein the rim of each cup of the plurality of cups is positionable on the slot lip within the associated slot of the plurality of slots when the cup is fully inserted into the associated slot.

5. The food storage assembly of claim 4, wherein the rim has a height being equal to a distance between the slot lip of the associated slot and a top surface of the platform wherein the rim is coplanar with the top surface of the platform when the cup is fully inserted into the associated slot.

6. (canceled)

7. The food storage assembly of claim 1, the lid further comprising:
a panel having a panel top side; and
a lid lip being coupled to and extending downwardly from the panel, the lid lip releasably engaging a perimeter edge of the platform to releasably couple the lid to the tray.

8. The food storage assembly of claim 7, further comprising:
a lid depression extending into the panel top side of the panel of the lid; and
a pair of notches extending into a bottom end of each leg of the pair of legs of the tray, the pair of notches having a shape being configured to complement a shape of an outer edge of the lid depression wherein the pair of legs are configured to releasably engage the lid to facilitate a user in stacking the tray on a second tray when the lid is coupled to the second tray.

9. A food storage assembly comprising:
a tray having a platform and a pair of legs, the platform being coupled to and extending between the pair of legs wherein the pair of legs is configured to support the platform over a surface, the platform having a top surface, the pair of legs being positioned on opposing lateral edges of the platform, each leg of the pair of legs having a bottom end being distally positioned relative to the platform, each leg of the pair of legs having a length being coextensive with the opposing lateral edges of the platform, each leg of the pair of legs having a front end and a back end being perpendicular to the opposing lateral edges of the platform;
a tray depression extending into the top surface of the platform;
a plurality of slots extending through the platform, the plurality of slots being positioned within the tray depression, each slot of the plurality of slots being spaced from an adjacent slot of the plurality of slots;
a plurality of channels extending into the platform, each channel of the plurality of channels being positioned around a respective slot of the plurality of slots to define a slot lip extending into the respective slot;
a plurality of cups, each cup of the plurality of cups being removably positionable within an associated slot of the plurality of slots, each cup of the plurality of cups having a volume between 3.0 fluid ounces and 9.0 fluid ounces, each cup of the plurality of cups including:
a base wall, the base wall being circular, the base wall being planar;
a peripheral wall being coupled to and extending upwardly from the base wall to define the volume; and
a rim being coupled to and extending outwardly from the peripheral wall, the rim being positionable on the slot lip within the associated slot when the cup is fully inserted into the associated slot, the rim having a height being equal to a distance between the slot lip of the associated slot and the tray depression wherein the rim is coplanar with the tray depression when the cup is fully inserted into the associated slot;
a lid being removably couplable to the tray, the lid covering the plurality of slots when the lid is coupled to the tray, the lid including:
a panel having a panel top side;
a lid depression extending into the panel top side; and
a lid lip being coupled to and extending downwardly from the panel, the lid lip releasably engaging a perimeter edge of the tray depression to releasably couple the lid to the tray, the lid lip being aligned with the lid depression;
a pair of notches extending into the bottom end of each leg of the pair of legs of the tray, each notch of the pair of notches being positioned on a respective one of the front end and the back end of the pair of legs, the pair of notches having a shape being configured to complement a shape of an outer edge of the lid depression wherein the pair of legs are configured to releasably engage the lid to facilitate a user in stacking the tray on a second tray when the lid is coupled to the second tray; and
a plurality of caps, each cap of the plurality of caps being removably couplable to an associated cup of the plurality of cups while the lid is coupled to the tray wherein each cap of the plurality of caps is configured to close the associated cup of the plurality of cups and wherein the lid inhibits removal of the plurality of cups from the plurality of slots, each cap of the plurality of caps including:
a plate having a diameter being complementary to a diameter of the rim wherein the plate is positionable to rest on the rim while each cap of the plurality of caps is coupled to the associated cup of the plurality of cups, the plate being planar; and
a ridge being coupled to and extending upwardly from the plate wherein the ridge is configured to facilitate removal of each cap of the plurality of caps from the associated cup of the plurality of cups, the ridge being positioned to cover a perimeter edge of the plate, the ridge having a height being less than a distance between the tray depression and the lid depression wherein each cap of the plurality of caps is couplable to the associated cup of the plurality of cups while the associated cup of the plurality of cups is positioned within the associated slot of the plurality of slots and while the panel of the lid is positioned directly adjacent to the ridge to inhibit the plurality of cups from moving upwardly relative to the top surface of the platform.

10. The food storage assembly of claim 1, each cap of the plurality of caps further comprising:
a plate having a diameter being complementary to a diameter of the rim wherein the plate is positionable to rest on the rim while each cap of the plurality of caps is coupled to the associated cup of the plurality of cups; and
a ridge being coupled to and extending upwardly from the plate wherein the ridge is configured to facilitate removal of each cap of the plurality of caps from the associated cup of the plurality of cups.

11. The food storage assembly of claim 10, wherein the ridge is positioned to cover a perimeter edge of the plate.

12. The food storage assembly of claim 11, wherein the ridge has a height being less than a distance between the tray depression and the lid depression wherein each cap of the plurality of caps is couplable to the associated cup of the plurality of cups while the associated cup of the plurality of cups is positioned within the associated slot of the plurality of slots and wherein the panel of the lid is positioned adjacent to the ridge to inhibit the plurality of cups from moving upwardly relative to the top surface of the platform.
